(19) United States
(12) Patent Application Publication
(10) Pub. No.: US 2015/0154840 A1
(43) Pub. Date: Jun. 4, 2015

(54) SYSTEM AND METHOD FOR MANAGING VIDEO ANALYTICS RESULTS

(71) Applicant: iWatchLife Inc., Ottawa (CA)

(72) Inventors: Charles Black, Gatineau (CA); Jason Phillips, Lower Sackville (CA); Robert Laganiere, Gatineau (CA); Pascal Blais, Ottawa (CA)

(21) Appl. No.: 14/415,781

(22) PCT Filed: Jul. 19, 2013
(86) PCT No.: PCT/CA2013/050563

§ 371 Date: Jan. 20, 2015

Related U.S. Application Data
(60) Provisional application No. 61/674,074, filed on Jul. 20, 2012.

(51) Int. Cl. G08B 13/196; G06K 9/00; H04N 7/18

(52) U.S. Cl. CPC G08B 13/19684; H04N 7/188; G06K 9/00771; G06K 9/00711; G08B 13/19654; G06K 2009/00738

(57) ABSTRACT

Video data relating to a field of view is captured by a video camera. The captured video data is provided to a cloud-based processor via a communication network and is processed. thereon according to a video analytics process to detect an actionable event within the captured video data and, in response to a detected actionable event, an alert signal relating is transmitted to an electronic communication device that is associated with a user. Based on the alert signal an alert message is displayed via a display portion of the electronic communication device and a user interface is provided in association with the displaying of the alert message supporting selection by the user of a video-display device. A user input indicative of selection of the video display device is received via the user interface. The captured video data is then displayed in the human intelligible form on the video display device.

### CROSS-REFERENCES TO RELATED APPLICATIONS

This application is a national stage application claiming benefit to International Application PCT/CA2013/050563 filed Jul. 19, 2013 which claims the benefit of U.S. Provisional Patent Application No. 61/674,074, filed Jul. 20, 2012, and incorporates the disclosure of each application by reference.

### FIELD OF THE INVENTION

The instant invention relates generally to video analytics, and more particularly to a system and method for managing the distribution of video analytics results including alert messages and video content.

### BACKGROUND OF THE INVENTION

The use of video cameras in security and surveillance applications has increased dramatically over the last several decades, such as for instance for the monitoring of remote locations, entry/exit points of buildings, high-value assets, public places and even private residences, etc. The increased use of video cameras is attributable in part to as perceived need to guard against terrorism and other forms of criminal activity, as well as the fact that recent technological advancements have made high-quality network cameras more affordable and therefore more widely available to the general public. Further, many consumer electronic devices that are on the market today are equipped with high quality video cameras, which allow such devices to be used for capturing video data for social media applications, for monitoring, children or caregivers, or for other similar purposes.

On the one hand, the increased availability and affordability of video cameras offers the potential of allowing a wider variety of users, from individual homeowners to small business owners, to set up relatively sophisticated systems to remotely monitor for the occurrence of an event of interest. On the other hand, such users now face the difficult task of monitoring all of the video data that is captured, and of determining when an event of interest is occurring, etc. Fortunately, the need to have a human operator review the captured video data is greatly reduced or eliminated when video analytics processing of the captured video data is performed. Video analytics processing electronically recognizes the significant features within a series of frames, and allows the system to issue alerts when specific types of events occur. That being said, the user must still receive and review the alerts, some of which may he false alarms. and then review video footage relating to such alerts, etc.

In some instances, a user may receive alerts via, a mobile device and or at a time that is inconvenient. Under these and other similar circumstances, the user either must dismiss the alert and potentially miss an event of interest, or the user must stop what he or she is doing in order to review the alert message and/or review video footage relating to the alert. Further, for non-security applications the alert may he of direct interest to the user, but may instead relate to an event that the user wishes to share with someone else. In this case, the user must additionally attempt to contact the party with whom the event is to he shared, and then arrange to have said party view the event. As a result, the alerts that are issued in current video analytics systems are inconvenient and inefficient.

It would be advantageous to provide a method and system that overcomes least some of the above-mentioned limitations of the prior art.

### SUMMARY OF EMBODIMENTS OF THE INVENTION

In accordance with an aspect of the invention there is provided a video analytics system, comprising: a video camera for capturing video data and for providing a data signal comprising the captured video data, the video camera associated with a user; at least one cloud-based processor that is in communication with the video camera via a communication network, the at least one cloud-based processor for receiving the data signal from the video camera via the communication network and having in execution thereon a video analytics process for processing the captured video data according to a predetermined processing criterion; a video-display device disposed at a location that is remote from the video camera; an electronic communication device in communication with the at least one cloud-based processor, the electronic communication device associated with the user and comprising a display portion and a communication circuit, the communication circuit for receiving an alert signal from the at least one cloud-based processor in dependence upon the video analytics process detecting an actionable event within the captured video data; and a user interface provided via the display portion or the electronic communication device, the user interface configured for sending a control signal from the communication circuit of the electronic communication device in response to receiving a user input, the control signal for providing captured video data from the video camera to the video-display device, wherein the video-display device is other than the display portion of the electronic communication device.

In accordance with another embodiment of the invention there is provided a video analytics method, comprising: using a video camera, capturing video data relating to a field of view of the video camera; providing data comprising the captured video data from the video camera to a cloud-based processor via a communication network; processing the video data according to a video analytics process that is in execution on the cloud-based processor, to detect an actionable event within the captured video data; sending an alert signal relating to the detected actionable event to an electronic communication device that is associated with a user; displaying an alert message via a display portion of the electronic communication device in response to receiving the alert signal at the electronic communication device; providing a user interface in association with the displaying of the alert message, the user interface supporting selection by the user of at least one video-display device for receiving the captured video data relating to the actionable event and for displaying the captured video data in a human intelligible form; receiving from the user, via the user interface, a user input indicative of selection of the at least one video display device; and using the selected at least one video-display device, displaying the captured video data in the human intelligible form.

In accordance with another embodiment of the invention there is provided a video analytics method, comprising: capturing video data at a source end; providing the captured video data from the source end to a cloud-based video analytics engine via a communication network; in response to the cloud-based video analytics engine detecting an actionable event within the captured video data, sending an alert signal a user device; displaying a human-intelligible alert message to a user via the user device; receiving a video destination selection from the user via the user device; and based on the video destination selection, controlling delivery of video data that is captured at the source end to a display device other than a display portion of the user device.

In accordance with another embodiment of the invention there is provided a video analytics system, comprising: a video camera for capturing video data and for providing a data signal comprising the captured video data via a communication network; at least one cloud-based processor in communication with the video camera via the communication network, the at least one cloud-based processor having in execution thereon a video analytics process for processing the captured video data according to predetermined processing criteria; a first electronic communication device in communication with the at least one cloud-based processor, the first electronic communication device associated with a first user and comprising a display portion and a communication circuit, the communication circuit for receiving a first alert signal from the at least one cloud-based processor in dependence upon the video analytics process detecting an actionable event within the captured video data and having as first user interface configured for providing a redirection signal in response to receiving a user input from the first user; and a second electronic communication device in communication with the at least one cloud-based processor, the second electronic communication device associated with a second user and comprising a display portion and a communication circuit, the communication circuit for receiving a second alert signal based on the redirection signal via the communication network in response to the user input from the first user.

In accordance with another embodiment of the invention there is provided a video analytics method, comprising; capturing video data at a source end; providing the captured video data from the source end to a cloud-based processor via a communication network, the cloud-based processor having in execution thereon a video analytics process; in response to the video analytics process detecting an actionable event within the captured video data, sending a first alert signal from the cloud-based processor to a first user device; displaying a human-intelligible alert message to a first user via the first user device; receiving a redirection selection from the first user via the first user device; sending a signal indicative of the redirection selection from the first user device to the cloud-based processor; and based on the redirection selection, sending a second alert signal relating to the detected actionable event from the cloud-based processor to a second user device, via the communication network.

In accordance with another embodiment of the invention there is provided a video analytics system, comprising: a video camera for capturing video data and for providing a data signal comprising the captured video data via a communication network; at least one cloud-based processor in communication with the video camera via the communication network, the at least one cloud-based processor having in execution thereon an analytics process for receiving the captured video data according to predetermined processing criteria and for determining a first actionable event related thereto; a first electronic communication device in communication with the at least one cloud-based processor, the first electronic, communication device associated with a first use and comprising a display portion and a communication circuit, the communication circuit for receiving a first alert signal from the at least one cloud-based processor in dependence upon detection of the first actionable event and having a first user interface configured the providing a redirection signal in response to receiving a user input from the first user; and a second electronic communication device in communication with the at least one cloud-based processor, the second electronic communication device associated with a second user and comprising a display portion and a communication circuit, the communication circuit for receiving a second alert signal from the at least one cloud-based processor via the communication network in response to the at least one cloud-based processor receiving the redirection signal from the first electronic communication device.

In accordance with another embodiment of the invention there is provided a video analytics system, comprising; a video camera for capturing video data and for providing a data signal comprising the captured video data, the video camera associated with a user; at least one cloud-based processor that is in communication with the video camera via, a communication network, the at least one cloud-based processor the receiving the data signal from the video camera via the communication network and having in execution thereon it process for determining a first actionable event related, thereto; a video-display device disposed at a location that is remote from the video camera; an electronic communication device in communication with the at least one cloud-based processor, the electronic communication device associated with the user and comprising a display portion and a communication circuit, the communication circuit for receiving an alert signal from the at least one cloud-based processor in dependence upon detecting the actionable event; and a user interface provided via the display portion of the electronic communication device, the user interface configured for sending a control signal from the communication circuit of the electronic communication device in response to receiving a user input, the control signal for providing captured video data from the video camera to the video-display device, wherein the video-display device is other than the display portion of the electronic communication device.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified block, diagram of as system according to an embodiment of the instant invention.

FIG. 2 is a simplified block diagram of another system according to an embodiment of the instant invention.

FIG. 3 is a simplified illustration of a user interface according to an embodiment of the instant invention.

FIG. 4 is a simplified how diagram of a method according to an embodiment of the instant invention.

FIG. 5 is a simplified flow diagram of another method according to an embodiment of the instant invention.

FIG. 6 is a simplified flow diagram of another method according to an embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited, to the embodiments disclosed, but is to he accorded the widest scope consistent with the principles and features disclosed herein.

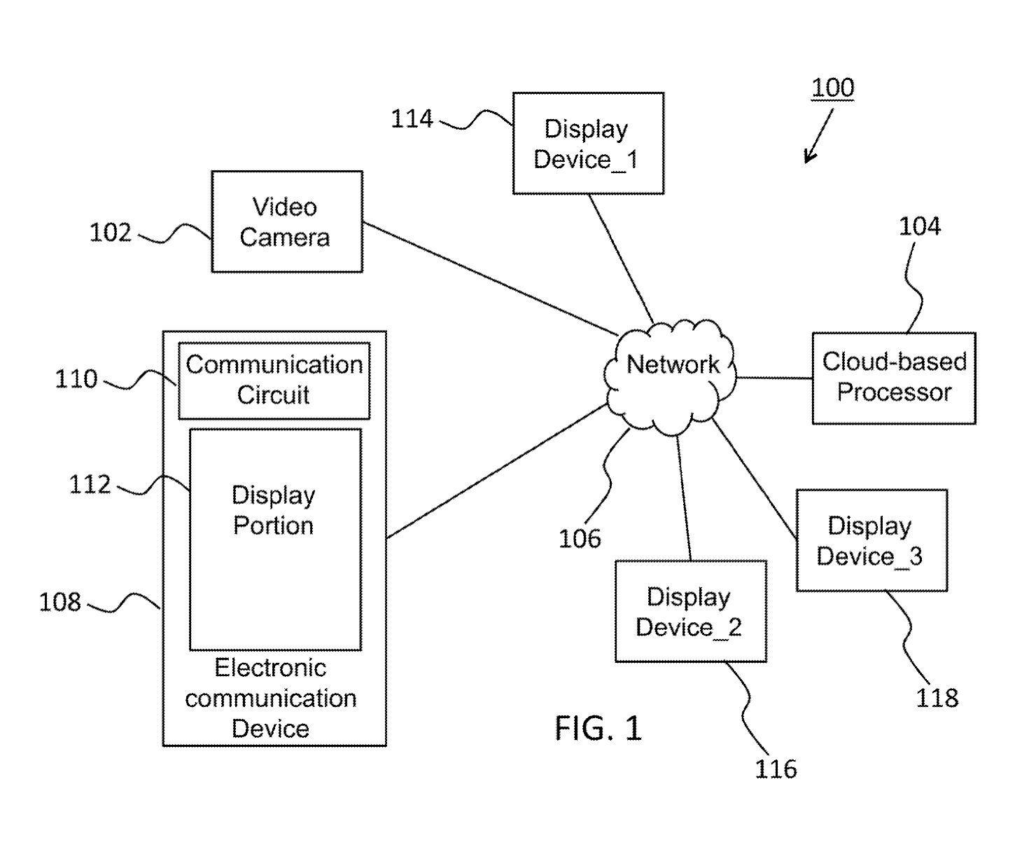

Referring to FIG. 1, shown is a simplified block diagram of a system in accordance with an embodiment of the instant invention. The system 100 includes a video camera 102, such as For instance a consumer grade Internet protocol (IP) video camera, for use in capturing video data at a source end. Optionally, the video camera 102 is a video camera that is embedded in a consumer electronic device such as for instance a smartphone, etc. Further optionally, a not illustrated data storage device is provided for storing a local copy of the captured video data at the source end. The video camera 102 is in communication with a cloud-based processor 104 via a communication network 106. For instance, the communication network 106 is a wide area network (WAN), such as the Internet. In the embodiment that is shown in FIG. 1, a video analytics process is in execution on the cloud-based processor 104. Optionally, the video analytics process is selected from as plurality of different video analytics processes that are stored in association with the cloud-based processor 104, and/or the captured video data is processed using more than one video analytics process in parallel or in series, etc. The cloud-based processor 104 comprises a general-purpose computer or server, or another similar processing device.

Also shown in FIG. 1 is an electronic communication device 108, which is carried by a user or otherwise associated therewith. By way of several specific and non-limiting examples, the electronic. communication device 108 is one of a smartphone, a tablet computer, a laptop computer, a desktop computer, a Personal Digital Assistant (PDA), a television, etc. The electronic communication device 108 includes a communication circuit 110 and a display portion 112. In the embodiment that is shown in FIG. 1, the communication circuit 10 supports communication between the electronic communication device 108 and the cloud-based processor 104 via the communications network 106. Optionally, the communication circuit 110 supports communication between the electronic communication device 108 and the cloud-based processor via another communication network, such as for instance a cellular telephone or cellular data network (not shown). Display devices 114-118 are shown in communication with the cloud-based processor 104 and with the video camera 102 via the communication network 106. Display devices 114-118 may be provided in the form of any of the following: a smartphone, a tablet computer, a laptop computer, a desktop computer, a PDA, a television, etc.

During use, the video camera 102 captures video data within a field of view of the video camera 102. Data comprising at least a portion of the captured video data is provided from the video camera 102 to the cloud-based processor 104 via the communication network 106, using known communication standards for providing video data via a network. Using a video analytics process that is in execution on the cloud-based processor 104, the captured video data is processed to detect an actionable event within the captured video data. When an actionable event is detected, an alert signal is provided from the cloud-based processor 104 to the electronic communication device 108. In the embodiment that is shown in FIG. 1, the alert signal is provided via the communication network 106. Alternatively, the alert signal is provided via another communication network, such as for instance a cellular telephone network or a cellular data network (not shown). The alert signal is received at the communication circuit 110, and an alert message based on the alert signal is displayed to the user via the display portion 112. For instance, the alert message merely indicates that an actionable event has been detected, or alternatively the alert message provides an indication of the nature of the actionable event.

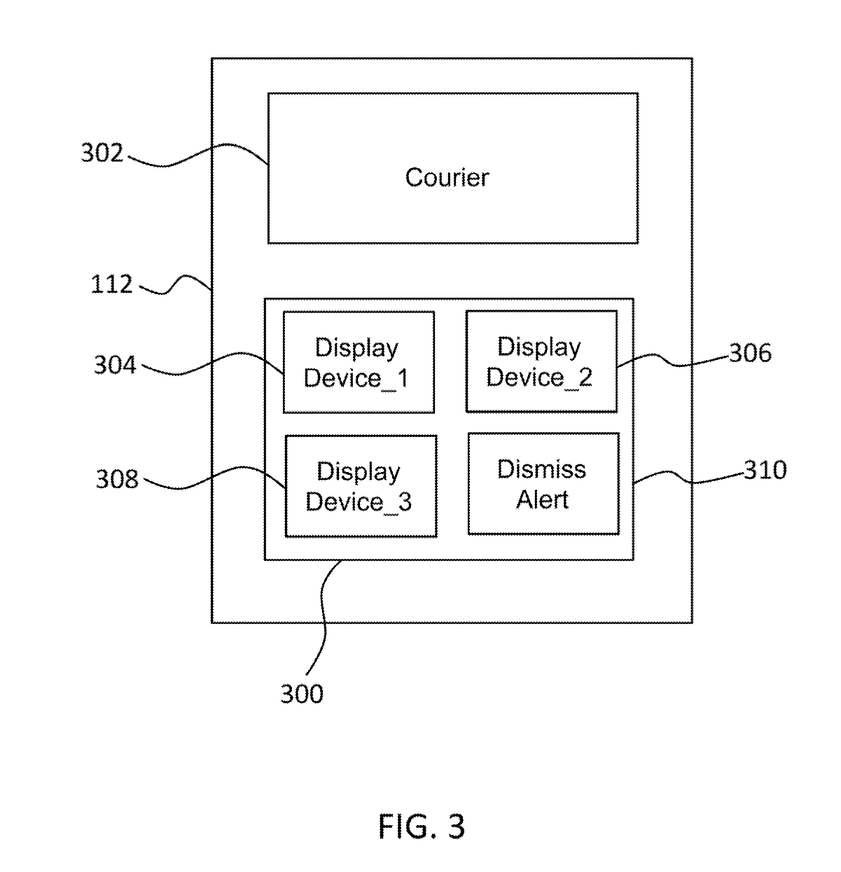

Now referring also to FIG. 3, a user interface 300 is displayed to the user, via the display portion 112 of the electronic communication device 108, in association with the displaying of the alert message 302. In the specific and non-limiting example that is shown in FIG. 3, the display potion 112 is a touch-sensitive display screen and the user interface 300 comprises a plurality of virtual buttons 304-310. The virtual buttons 304-308 are for selecting one of the display devices 114-118 for the displaying of captured video data relating to the detected actionable event. In addition, optional virtual button 310 is provided to allow the user to dismiss the alert.

Using the user interface 300, the user provides an indication for selecting of one of the display devices 114-118 for displaying the captured video data. For instance, the user touches the virtual button 304 for selecting the display device 114 (Display Device_1) for displaying the captured video data. In response to the user providing the indication via, the user interface 300, the communication circuit 110 of the electronic communication device 108 sends a control signal to the cloud-based processor 104. The control signal is for instructing the cloud-based processor 104 to provide the captured video data from the video camera 102 to the selected display device 114 via the communication network 106. In the embodiment that is shown in FIG. 1, the captured video data is provided from the video camera to the display device 114 either directly, or via the cloud-based processor 104.

The following discussion is provided as a non-limiting, practical example of the use of the system that has been described with reference to FIGS. 1 and 3, in this example, the user has set up the video camera 102 to monitor an area around the front door of his or her house. The video camera 102 captures video data, at least a portion of which is provided to the cloud-based processor 104 via the network 106, which in this example is the Internet. A video analytics process in execution on the cloud-based processor 104 is used to detect an actionable event, such as for instance a courier approaching the front door of the house. When the actionable event is detected, the cloud-based processor 104 sends an alert signal to the user's electronic communication device 108, such as tor instance a smartphone. An alert message 302 “courier” is displayed to the user via the display potion 112 of the electronic communication device 108, and user interface 300 is provided in association with the display of the alert message 302. Since the user is currently away from his or her house at the time the alert message 302 is displayed, the user provides an indication via the user interface 300 for selecting the display device 114 for displaying the video data from the video camera 102. In this example, the display device 114 is a tablet computer associated with the user's spouse. In response to receiving the indication from the user, the user interface 300 causes the communication circuit 110 of user device 108 to send a control signal to the cloud-based processor 104, which in turn causes the cloud-based processor 104 to provide the video data that is captured by the video camera 102 to the display device 114. The user's spouse views the captured video data and takes the appropriate action to greet the courier at the door.

In another example, the user receives an alert message via the electronic communication device 108 as described in the previous example, and selects another display device for viewing the captured video data. For instance, the user is at home and receives an alert message indicating that his or her spouse is recording video of their child's school play. The user does not wish to view the video via the small display portion 112 of the electronic communication device 108, and so the user provides an indication via the user interface 300 for selecting the display device 116 (Display Device_2) for displaying the video data from the video camera 102. in this example, the display device 116 is a high definition television (HDTV) in the user's home. In response to receiving the indication from the user, the user interface 300 causes the communication circuit 110 of user device 108 to send a control signal to the cloud-based processor 104, which in turn causes the cloud-based processor 104 to provide the video data that is captured by the video camera 102 to the display device 116. The user then watches the video of the school play via the HDTV.

Optionally, the user interface 300 displays only active display devices. For instance, a display device is listed for being selected via the user interface 300 only when activity is detected on the device. Alternatively, a display device is listed whenever it is not in standby mode or sleep mode, etc.

Optionally, selection of one of the display devices 114-118 via the user interface 300 causes the communication circuit 110 of the electronic communication device 108 to send a control signal in the form of a redirection signal to the cloud-based processor 104. Subsequently, in response to receiving the redirection signal, the cloud-based processor 104 sends a second alert signal to the selected one of the display devices 114-118. For instance, in response to receiving an alert signal and viewing an alert message via the display portion 112 of electronic communication device 108, a first user touches the virtual button 304 for redirecting the alert signal to the display device 114. In response to the user providing the indication via the user interlace 300, the communication circuit 110 of the electronic communication device 108 sends a control signal to the cloud-based processor 104 in the form of a redirection signal. The redirection signal is for instructing the cloud-based processor 104 to provide a second alert signal to the selected display device 114. In response to receiving the second alert signal, the selected display device displays an alert message, and a second user associated with the selected display device is prompted to view the captured video data that triggered the sending of the alert signal or subsequently captured video data, or alternatively to dismiss the alert, etc.

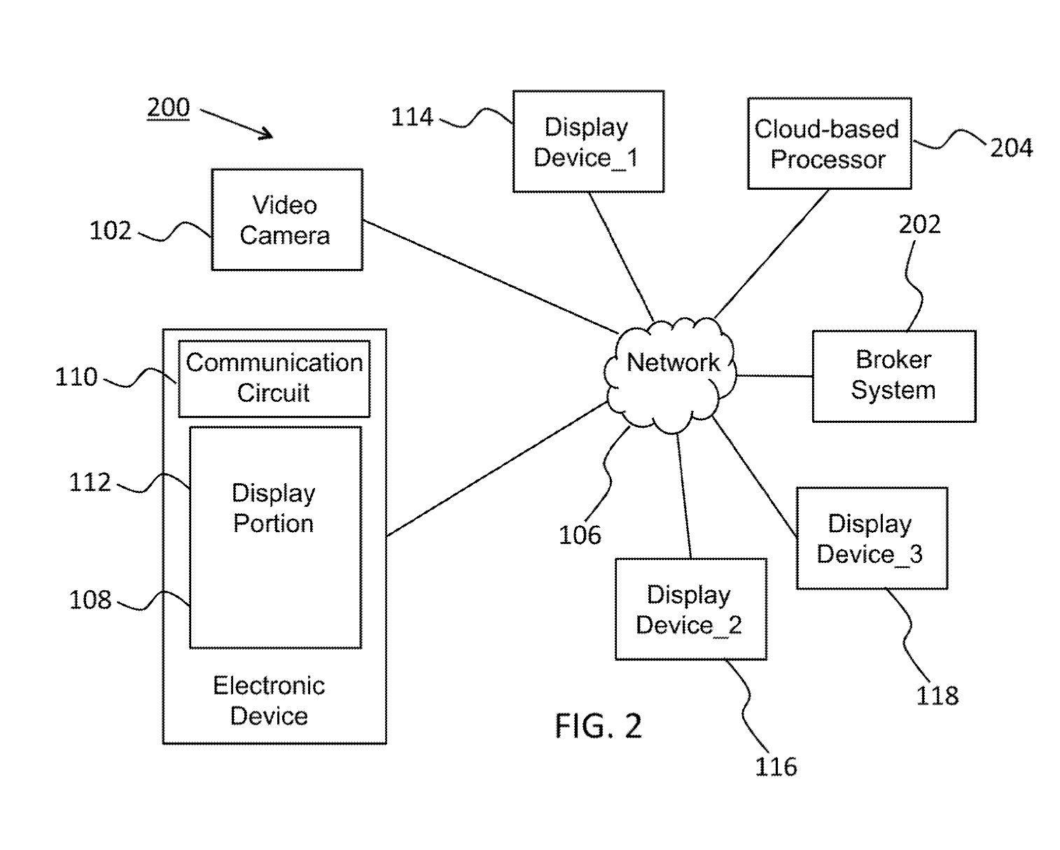

Referring now to FIG. 2, shown is a simplified block diagram of another system in accordance with an embodiment of the instant invention. The system 200 includes a video camera 102, such as for instance a consumer grade Internet protocol (IP) video camera, for use in capturing video data at a source end. Optionally, the video camera 102 is a video camera that is embedded in a consumer electronic device such as for instance a smartphone, etc. Further optionally, a not illustrated data storage device is provided for storing a local copy of the captured video data at the source end. The video camera 102 is in communication with a broker system 202 via a communication network 106. For instance, the communication network 106 is a wide area network (WAN), such as the Internet. In the embodiment that is shown in FIG. 2, the broker system 202 is in communication with a cloud-based processor 204 via the communication network 106. The cloud-based processor 204 has in execution thereon a video analytics process for processing the video data that is captured using the video camera 102. Although only one cloud-based processor 204 is shown in FIG. 2, it should be understood that optionally the broker system 202 is in communication with a plurality of cloud-based processors via the communication network 106. Optionally, the video analytics process is selected from a plurality of different video analytics processes that are stored in association with the cloud-based processor 204. The cloud-based processor 104 is a general-purpose computer or server, or another similar processing device.

Also shown in FIG. 2 is an electronic communication device 108, which is carried by a user or otherwise associated therewith. By way of several specific and non-limiting examples, the electronic communication device 108 is one of a smartphone, a tablet computer, a laptop computer, a desktop computer, a Personal Digital Assistant (PDA), a television, etc. The electronic communication device 108 includes a communication circuit 110 and a display portion 112. In the embodiment that is shown in FIG. 2, the communication circuit 110 supports communication between the electronic communication device 108 and the broker system 202 via the communications network 106. Optionally, the communication circuit 110 supports communication between the electronic communication device 108 and the broker system 202 via another communication network, such as for instance a cellular telephone or data network (not shown). Display devices 114-118 are shown in communication with the broker system 202 and with the video camera 102 via the communication network 106. Display devices 114-118 may be provided in the form of any of the following: smartphone, a tablet computer, a laptop computer, a desktop computer, a FDA, a television, etc.

During use, the video camera 102 captures video data within a field of view of the video camera 102. Data comprising at least a portion of the captured video data is provided from the video camera 102 to the broker system 202 via the communication network 106, using known communication standards for providing video data via a network. The captured video data is either provided to the broker system 202 along with an indication of the processing that is to be performed on the video data, or the broker system 202 retrieves profile data from an account file and determines the processing that is to be performed on the video data based on previously provided information. The broker system 202 provides the captured video data to the cloud-based processor 204, which has in execution thereon a video analytics process tor performing the processing on the captured video data. Using the video analytics process that is in execution on the cloud-based processor 204. the captured video data is processed to detect an actionable event within the captured video data When an actionable event is detected, an alert signal s provided to the electronic communication device 108, either directly from the cloud-based processor 204 or via the broker system 202. In the embodiment that is shown in FIG. 2, the alert signal is provided via the communication network 108. Alternatively, the alert signal is provided via another communication network, such as for instance a cellular telephone network or cellular data network (not shown). The alert signal is received at the communication circuit 110, and an alert message based on the alert signal is displayed to the user via the display portion 112. For instance, the alert message merely indicates that an actionable event has been detected, or alternatively the alert message provides an indication of the nature of the actionable event.

Now referring also to FIG. 3, the user interlace 300 is displayed to the user, via the display portion 112 of the electronic communication device 108, in association with the displaying of the alert message 302. In the specific and non-limiting example that is shown in FIG. 3, the display potion 112 is a touch-sensitive display screen and the user interface 300 comprises a plurality of virtual buttons 304-310. The virtual buttons 304-308 are or selecting one of the display devices 114-118 for the displaying of captured video data relating to the detected actionable event. In addition, optional virtual button 310 is provided to allow the user to dismiss the a

Using the user interface 300, the user provides an indication for selecting of one of the display devices 114-118 for displaying the captured video data. For instance, the user touches the virtual button 304 for selecting the display device (Display Device_1) for displaying the captured video data. In response to the user providing the indication via the user interface 300, the communication circuit 110 of the electronic communication device 108 sends a control signal to the broker system 202. The control signal is for instructing the broker system 202 to provide the captured video data from the video camera 102 to the selected display device 114. In the embodiment that is shown in FIG. 2, the captured video data is provided from the video camera to the display device 114 either directly, or via the cloud-based processor 104.

As noted above, optionally the broker system 202 is in communication with a plurality of cloud-based processors, each of the cloud based processors having a different video analytics process in execution thereon. Optionally, the broker system 202 causes the captured video data to be provided to more than one of the plurality of cloud-based processors, such that different video analytics processes are used to process the captured video data either in series or in parallel.

Optionally, selection of one of the display devices 114-118 via the user interface 300 causes the communication circuit 110 of the electronic communication device 108 to send a control signal in the form of a redirection signal to the broker system 202. Subsequently, in response to receiving the redirection signal, the broker system 202 sends a second alert signal to the selected one of the display devices 114-118. For instance, in response to receiving an alert signal and viewing an alert message via the display portion 112 of electronic communication device 108, a first user touches the virtual button 304 for redirecting the alert signal to the display device 114. In response to the user providing the indication via the user interface 300, the communication circuit 110 of the electronic communication device 108 sends a control signal to the broker system 202 in the from of a redirection signal. The redirection signal is for instructing the broker system 202 to provide a second alert signal to the selected display device 114. In response to receiving the second alert signal, the selected display device displays an alert message, and a second user associated with the selected display device is prompted to view the captured video data that triggered the sending of the alert signal or subsequently captured video data, or alternatively to dismiss the alert, etc.

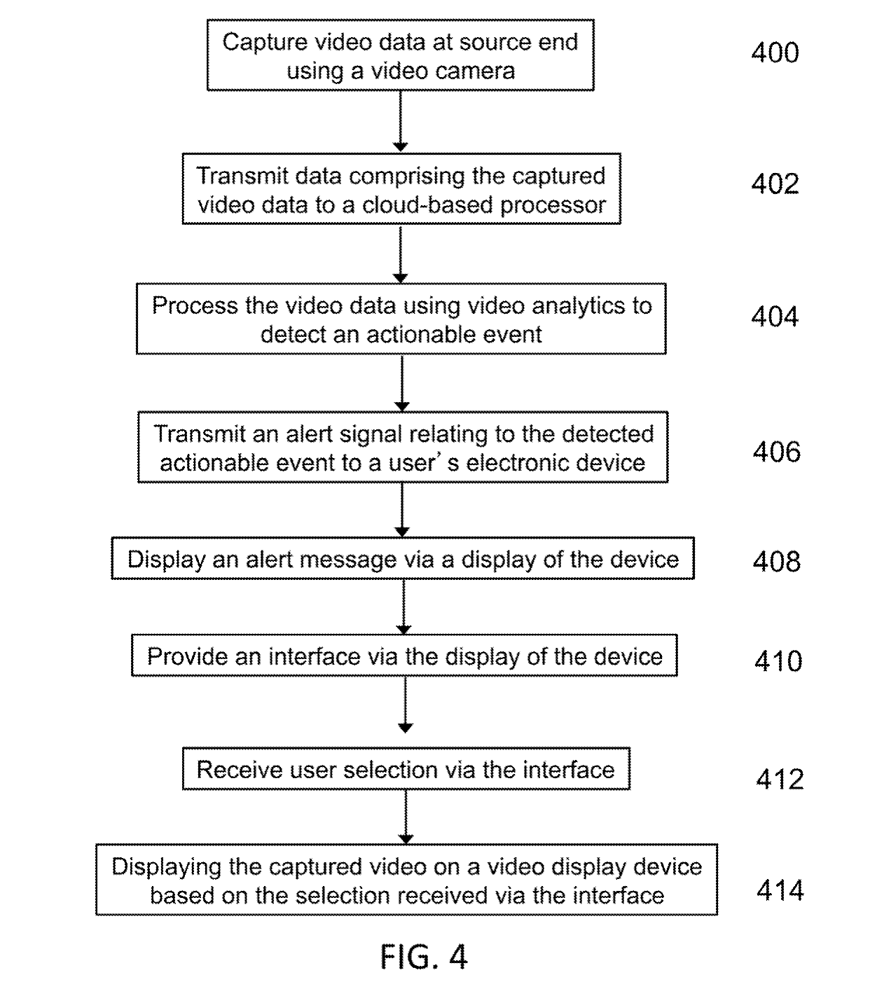

Referring now to FIG. 4, shown is a simplified flow diagram of a method according to an embodiment of the instant invention. At 400 a video camera disposed at a source end is used to capture video data relating to a field of view of the video camera. At 402 data comprising the captured video data, or at least a portion thereof, is provided from the video camera to a cloud-based processor via a communication network. For instance, the communication network is a wide area network such the Internet. At 404 the video data is processed according to a video analytics process that is in execution on the cloud-based processor, in order to detect an actionable event within the captured video data. By way of some specific and non-limiting examples, an actionable event includes a person approaching an entry point of a building, a child waking up from a nap, a neighbor's pet entering a yard, an item being removed from a known location, etc. When an actionable event is detected, then at 406 an alert signal relating to the detected actionable event is sent to an electronic communication device that is associated with a user. At 408 an alert message is displayed to the user via a display portion of the electronic communication device, in response to receiving the alert signal at the electronic communication device. In association with the displaying of the alert message a user interface is displayed at 410, the user interface supporting selection by the user of at least one video-display device, other than the display portion of the electronic communication device, for receiving the captured video data relating to the actionable event. At 412 a user input that is indicative of selection of the at least one video display device is received from the user, via the user interface. At 414 the captured video data is displayed, in human intelligible form, via the selected at least one video-display device.

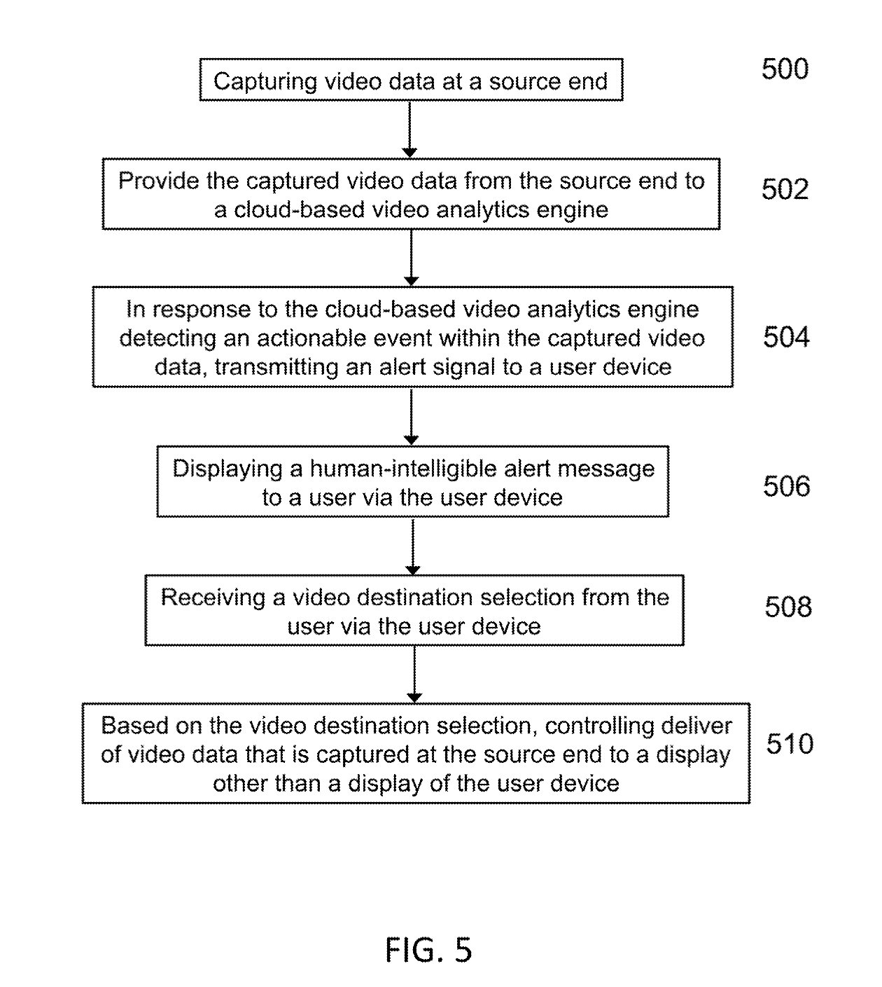

Referring now FIG. 5 shown is a simplified flow diagram of another method according to an embodiment of the instant invention. At 500 video data is captured at a source end in particular, a video camera disposed at the source end is used to capture video data relating to a field of view of the video camera. At 502 the captured video data is provided from the source end to a cloud-based video analytics engine via a communication network. For instance, the communication network is a wide area network such the Internet. At 504, in response to the cloud-based video analytics engine detecting an actionable event within the captured video data, an alert signal is sent to a user device. At 506 a human-intelligible alert message is displayed to a user, via the user device. At 508 a video destination selection is received from the user via the user device. At 510 the video destination selection is used for controlling delivery of video data that is captured at the source end to a display device other than a display portion of the user device.

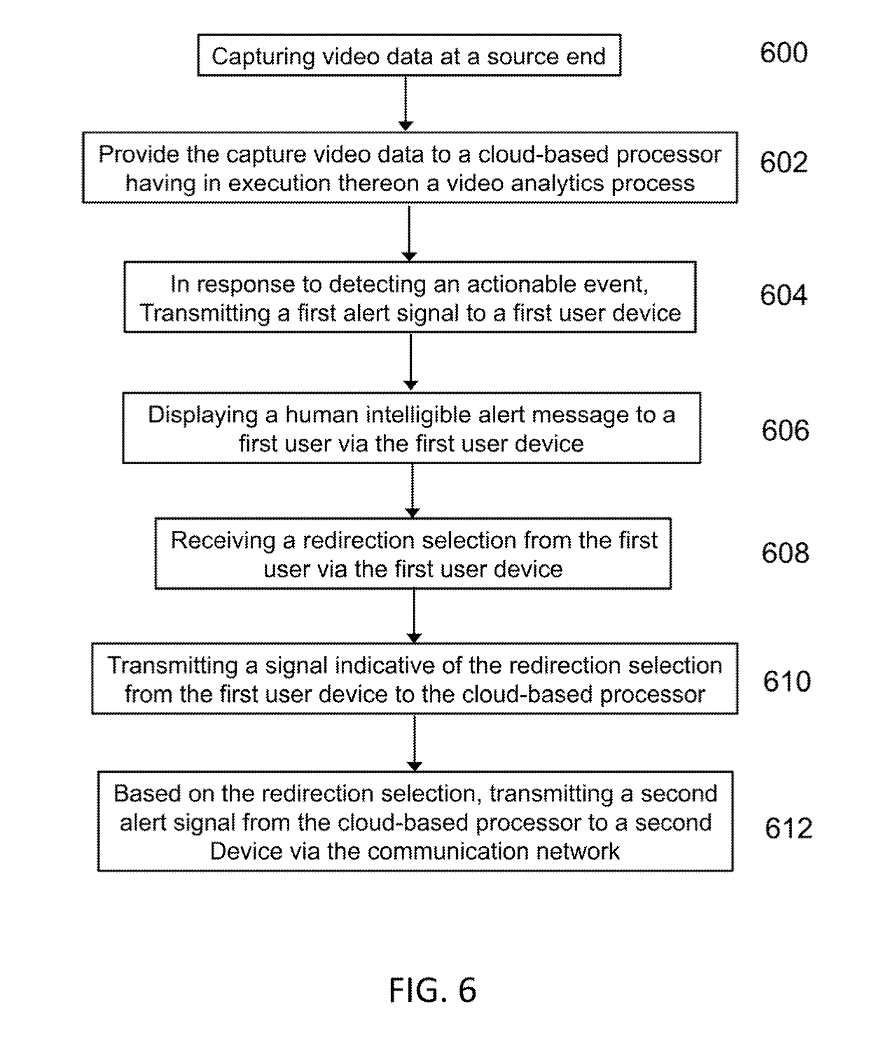

Referring now to FIG. 6 shown is a simplified flow diagram of another method according to an embodiment of the instant invention. At 600 video data is captured at a source end. In particular, a video camera disposed at the source end is used to capture video data relating to a field of view of the video camera. At 602 the captured video data is provided from the source end to a cloud-based processor via a communication network, the cloud-based processor having in execution thereon a video analytics process. At 604, in response to the video analytics process detecting an actionable event within the captured video data, a first alert signal is sent from the cloud-based processor to a first user device. At 606 a human-intelligible alert message is displayed to a first user via the first user device. At 608 a redirection selection is received, from the first user via the first User device. At 610 a signal indicative of the redirection selection is sent from the first user device to the cloud-based processor. At 612, based on the redirection selection, a second alert signal relating to the detected actionable event is sent from the cloud-based processor to a second user device via, the communication network.

Numerous other embodiments may be envisaged without departing from the scope of the invention.

1. A video analytics system, comprising:
a video camera for capturing video data and for providing a data signal comprising the captured video data, the video camera associated with a user;
at least one cloud-based processor that is in communication with the video camera via a communication network, the at least one cloud-based processor for receiving the data signal from the video camera via the communication network and having in execution thereon a video analytics process for processing the captured video data according to a predetermined processing criterion;
a video-display device disposed at a location that is remote from the video camera;
an electronic communication device in communication with the at least one cloud-based processor, the electronic communication device associated with the user and comprising a display portion and a communication circuit, the communication circuit for receiving an alert signal from the at least one cloud-based processor in dependence upon the video analytics process detecting an actionable event within the captured video data; and
a user interface provided via the display portion of the electronic communication device, the user interface configured for sending a control signal from the communication circuit of the electronic communication device in response to receiving a user input, the control signal for providing captured video data from the video camera to the video-display device, the video-display device other than the display portion of the electronic communication device.

2. The system of claim 1 wherein the video-display device is a first video-display device of a plurality of video-display devices, and wherein the user interface supports selection by the user of any video-display device of the plurality of video-display devices.

3. The system of claim 1 wherein the at least one cloud-based processor comprises a first cloud-based processor associated with a broker system and a second cloud-based processor that is in communication with the broker system, the second cloud-based processor having in execution thereon the video analytics process, wherein the first processor is responsive to the command signal for providing the captured video data from the video camera to the user-selected display device.

4. The system of claim 1 wherein the at least one cloud-based processor comprises one cloud-based processor having in execution thereon the video analytics process and being responsive to the command signal for providing the captured video data from the video camera to the user-selected display device.

5. The system of claim 1 wherein the display portion of the electronic communication device is touch-sensitive, and wherein the user interface comprises at least one virtual button that is displayed via the touch-sensitive display portion of the electronic communication device.

6. The system of claim 1 wherein the electronic communication device is a smartphone.

7. The system of claim 1 wherein the electronic communication device is a tablet computer.

8. The system of claim 1 wherein the video-display device is a television.

9. The system of claim 1 wherein the video-display device is one of a desktop computer, a tablet computer and a laptop computer.

10. The system of claim 1 wherein the video-display device is a smartphone.

11. The system of claim 1 wherein the captured video data is provided via the at least one cloud based processor to the video-display device, the electronic communication device comprising circuitry for transmitting the control signal from the electronic device to the at least one cloud-based processor.

12. A video analytics method, comprising:
using a video camera, capturing video data relating to a field of view of the video camera;
providing data comprising the captured video data from the video camera to a cloud-based processor via a communication network;
processing the video data according to a video analytics process that is in execution on the cloud-based processor, to detect an actionable event within the captured video data;
sending an alert signal relating to the detected actionable event to an electronic communication device that is associated with a user;
displaying an alert message via a display portion of the electronic communication device in response to receiving the alert signal at the electronic communication device;
providing a user interface in association with the displaying of the alert message, the user interface supporting selection by the user of at least one video-display device for receiving the captured video data relating to the actionable event and for displaying the captured video data in a human intelligible form;
receiving from the user, via the user interface, a user input indicative of selection of the at least one video display device; and
using the selected at least one video-display device, displaying the captured video data in the human intelligible form.

13. The method according to claim 12 wherein the at least one video-display device is a first video-display device selected from a plurality of video-display devices.

14. The method according to claim 12 wherein the data signal comprising the captured video data is provided to the cloud-based processor via a broker system, and wherein the broker system sends the alert signal to the electronic communication device in response to the cloud-based processor detecting the actionable event within the captured video data.

15. The method according to claim 12 wherein the selected at least one video-display device receives the captured video data from the video camera via the communication network.

16. The method according to claim 14 wherein the selected at least one video-display device receives the captured video data from the broker system via the communication network.

17. A video analytics method, comprising:
capturing video data at a source end;
providing the captured video data from the source end to a cloud-based video analytics engine via a communication network;
in response to the cloud-based video analytics engine detecting an actionable event within the captured video data, sending an alert signal to a user device;
displaying a human-intelligible alert message to a user via the user device;
receiving a video destination selection from the user via the user device; and
based on the video destination selection, controlling delivery of video data that is captured at the source end to a display device other than a display portion of the user device.

18. The method of claim 17 wherein receiving a video destination selection from the user comprises displaying a user interface via the display portion of the user device, the user interface including an indication of at least one available video destination.

19-29. (canceled)
